(19) United States
(12) Patent Application Publication
(10) Pub. No.: US 2022/0058252 A1
(43) Pub. Date: Feb. 24, 2022

(54) DEVICE USE RIGHTS ALLOCATION METHOD, DEVICE, STORAGE MEDIUM AND ELECTRONIC APPARATUS

(71) Applicant: KOUBEI (SHANGHAI) INFORMATION TECHNOLOGY CO., LTD., Shanghai (CN)

(72) Inventors: Kuan LUO, Shanghai (CN); Xuan MAO, Shanghai (CN)

(21) Appl. No.: 17/518,944

(22) Filed: Nov. 4, 2021

Related U.S. Application Data
(63) Continuation of application No. PCT/CN2020/076868, filed on Feb. 27, 2020.

(30) Foreign Application Priority Data
May 8, 2019 (CN) 201910380996.6

(51) Int. Cl. G06F 21/32

(52) U.S. Cl. CPC G06F 21/32

(57) ABSTRACT

Methods, devices, storage media and electronic apparatuses for allocating equipment usage right are provided in this application, wherein the method includes: for each of one or more electronic equipment, obtaining biometric information of a user currently using the electronic equipment which is acquired by each electronic equipment in real time, to obtain a current usage state of the each electronic equipment, and based on the current usage state of the each electronic equipment, updating a historical usage record of the electronic equipment, based on the current usage state and/or the historical usage record of the each electronic equipment, determining one or more targeted using objects to be allocated with equipment usage right of corresponding electronic equipment; and sending information of the allocating result to the targeted using objects.

### CROSS-REFERENCES TO RELATED APPLICATIONS

This application is a continuation application of International Application, PCT/CN2020/076868, filed Feb. 27, 2020, which claims priority to Foreign Application, CN No. 201910380996.6, filed on May 8, 2019, and entitled “METHODS, DEVICES, STORAGE MEDIA AND ELECTRONIC APPARATUSES FOR ALLOCATING EQUIPMENT USAGE RIGHT”, the entire content of which is hereby incorporated by reference.

### TECHNICAL FIELD

This application relates to the field of biometric technology, and in particular to methods, devices, storage media, and electronic apparatuses for allocating equipment usage right.

### BACKGROUND

For a shop that is provided with electronic equipment such as entertainment electronic equipment and video game electronic equipment, in order to increase the volume of customers, the owner of the shop will provide coupons and the like to attract customers to use the equipment. However, for current electronic equipment, usage permission of the equipment is usually obtained by inserting one or more coins, swiping magnetic a card, passing through a turnstile and the like. A coin-activated electronic equipment cannot determine an identity of a user. An electronic equipment that is activated by swiping a magnetic card can only determine an identity of a cardholder through information stored in the magnetic card, and cannot determine the real identity of the person who swipes the card or the user who uses the equipment. Controlling entry and exit of a user to and from an enclosed venue through a turnstile cannot determine which equipment that the user actually uses after entering the venue. None of the above methods can determine the real identity of the user who uses the equipment, and thus cannot attract target customers.

For the above-mentioned problems in the related art, no effective solution has been proposed yet.

### SUMMARY

The embodiments of the present application provide methods, devices, storage media and electronic apparatuses for allocating equipment usage right, to at least solve the problem in the related art that the real identities of users using electronic equipment cannot be accurately obtained, and the target customers cannot be attracted, such that the electronic equipment can accurately detect the identity of current user, so as to determine the target customers based on more accurate user information.

According to one embodiment of the present application, a method of allocating equipment usage right is provided, the method including: for each of one or more electronic equipment, obtaining biometric information of a user currently using the electronic equipment which is acquired by the electronic equipment in real time, to obtain a current usage state of the electronic equipment, and based on the current usage state of the electronic equipment, updating a historical usage record of the electronic equipment, wherein the biometric information is obtained by a target sensor configured on the electronic equipment and indicates designated human biological characteristic; based on the current usage state and/or the historical usage record of each electronic equipment, determining one or more targeted using objects to be allocated with equipment usage right of corresponding electronic equipment and send information of the allocating result to the targeted using objects.

Further, the equipment usage right comprises a usage permission of corresponding electronic equipment and/or a discount right to consumed resources for using corresponding electronic equipment.

Further, determining one or more targeted using objects to be allocated with equipment usage right of corresponding electronic equipment based on the historical usage record of each of the electronic equipment includes: determining an idle time period for the corresponding electronic equipment based on the historical usage record of each of the electronic equipment, and determining one or more users who use an electronic equipment of a same type as the corresponding electronic equipment at a frequency higher than a preset threshold as the targeted using objects; and allocating equipment usage right of using the corresponding electronic equipment within the idle time period to the targeted using objects.

Further, determining targeted using objects to be allocated with equipment usage right of corresponding electronic equipment based on the current usage state of the electronic equipment includes: determining a currently unused electronic equipment based on the current usage state of each electronic equipment; based on current usage states of other electronic equipment in an area where the currently unused electronic equipment is located, determining one or more current users in the area, to obtain the targeted using objects; and allocating the equipment usage right of using the currently unused electronic equipment within a preset time period to the targeted using objects.

Further, determining targeted using objects to be allocated with equipment usage right of corresponding electronic equipment based on the current usage state and the historical usage record of the electronic equipment includes: based on the historical usage record of each electronic equipment, determining an idle time period for the corresponding electronic equipment; when the idle time period is reached, determining whether the corresponding electronic equipment is being used; if not, based on current usage states of other electronic equipment in an area where the currently unused electronic equipment is located, determining one or more current users in the area to obtain the targeted using objects; and allocating the equipment usage right of using the corresponding electronic equipment within the idle time period to the targeted using objects.

Further, sending information of the allocating result to the targeted using objects includes: pushing the information of the allocating result to a client of a mobile terminal of the targeted using object; and/or, sending the information of the allocating result to a mobile terminal of the targeted using object in a form of short message.

Further, the human biological characteristic includes at least one of the following: facial features, fingerprint features, and iris features.

Further, after obtaining the biometric information of the user currently using the electronic equipment which is acquired by the electronic equipment in real time, the method further includes: identifying the user currently using the electronic equipment according to the biometric information as a current user; and determining whether the current user has a usage permission; and closing the electronic equipment if the determination result is no.

According to another embodiment of the present application, a device for allocating equipment usage right is provided, including: an obtaining module configured to, for each of one or more electronic equipment, obtain biometric information of a user currently using the electronic equipment which is acquired by the electronic equipment in real time, to obtain a current usage state of each electronic equipment, and based on the current usage state of each electronic equipment, update a historical usage record of the electronic equipment, wherein the biometric information is obtained by a target sensor configured on the electronic equipment and indicates designated human biological characteristic; an allocating module configured to, based on the current usage state and/or the historical usage record of the electronic equipment, determine targeted using objects to be allocated with equipment usage right of corresponding electronic equipment; and a sending module configured to send information of the allocating result to the targeted using objects.

Further, the equipment usage right comprises a usage permission of corresponding electronic equipment and/or a discount right to consumed resources for using corresponding electronic equipment.

Further, the allocating module includes: a first determining unit configured to determine an idle time period for the corresponding electronic equipment based on the historical usage record of each electronic equipment, and determine one or more users who use an electronic equipment of the same type as the corresponding electronic equipment at a frequency higher than a preset threshold as the targeted using objects; and a first allocating unit configured to allocate equipment usage right of using the corresponding electronic equipment within the idle time period to the targeted using objects.

Further, the allocating module includes: determining a currently unused electronic equipment based on the current usage state of each electronic equipment; a second determining unit configured to, based on current usage states of other electronic equipment in an area where the currently unused electronic equipment is located, determine one or more current users in the area to obtain the targeted using objects; and a second allocating unit configured to allocate the equipment usage right of using the currently unused electronic equipment within a preset time period to the targeted using objects.

Further, the allocating module includes: a third determining unit configured to, based on the historical usage record of each electronic equipment, determine an idle time period for the corresponding electronic equipment; a determining unit configured to, when the idle time period is reached, determine whether the corresponding electronic equipment is being used; a fourth determining unit configured to, if not, based on current usage states of other electronic equipment in an area where the currently unused electronic equipment is located, determine one or more current users in the area to obtain the targeted using objects; and a third allocating unit configured to allocate equipment usage right of using the corresponding electronic equipment within the idle time period to the targeted using objects.

Further, the sending module includes: a pushing unit configured to push the information of the allocating result to clients of mobile terminals of the targeted using objects; and/or, a sending unit configured to send the information of the allocating result to mobile terminals of the targeted using objects in the form of short messages.

Further, the human biological characteristic includes at least one of: a facial feature, a fingerprint feature, and an iris feature.

Further, the device includes: an identifying module configured to, after obtaining the biometric information of the user currently using the electronic equipment which is acquired by the electronic equipment in real time, identify the user currently using the electronic equipment according to the biometric information as a current user; a determining module configured to determine whether the current user has a usage permission; and a closing module configured to close the electronic equipment if the determination result is no.

According to another embodiment of the present application, a non-volatile readable storage medium having computer readable instructions stored in the storage medium is provided, wherein the computer readable instructions are configured to, when running, perform the steps of any one of the above methods.

According to another embodiment of the present application, an electronic apparatus including a memory and a processor is provided, the memory storing computer-readable instructions, the processor being configured to run the computer-readable instructions to perform the steps of any one of the above methods.

With this application, by acquiring and recording biometric information of a user currently using the electronic equipment, the usage state of each electronic equipment can be recorded, and the current real-time usage state of each electronic equipment can be obtained, so as to use the current real-time usage state and historical records to formulate a strategy for allocating equipment usage right to electronic equipment, and then send the allocating results to the users designated by the strategy. It can solve the problem in the related art that the real information of users using electronic equipment cannot be accurately obtained, and the target customers cannot be attracted. It can accurately detect the identity of the user using electronic equipment, thereby determining the target customers based on more accurate user information, and attracting users to use electronic equipment through the equipment usage right allocated to the target customers, thus increasing the usage rate of each electronic equipment.

### BRIEF DESCRIPTION OF THE DRAWINGS

The drawings described here are used to provide a further understanding of the application and constitute a part of the application. The exemplary embodiments and descriptions of the application are used to explain the application and do not constitute an improper limitation of the application. In the drawings:

FIG. 1 is a flowchart of a method for allocating equipment usage right according to an embodiment of the present application;

FIG. 2 is a schematic diagram of a device for allocating equipment usage right according to an embodiment of the present application;

FIG. 3 is a block diagram of a hardware structure of an electronic apparatus according to an embodiment of the present application.

### DETAILED DESCRIPTION OF THE EMBODIMENTS

In order to enable those skilled in the art to better understand the solution of the application, the technical solutions in the embodiments of the application will be described clearly and completely in conjunction with the drawings in the embodiments of the application. Apparently, the described embodiments are only a part of the embodiments of the present application, not all of the embodiments. The embodiments in the present application and the features in the embodiments can be combined with each other if there is no conflict. Based on the embodiments in this application, all other embodiments obtained by those of ordinary skill in the art without creative work should fall within the protection scope of this application.

It should be noted that the terms “first” and “second” in the specification and claims of this application and the above-mentioned drawings are used to distinguish similar objects, and are not necessarily used to describe a specific order or sequence. It should be understood that the data used in this way can be interchanged under appropriate circumstances, so that the embodiments of the present application described herein can be implemented in a sequence other than those illustrated or described herein. In addition, the terms “including” and “having” and any variations of them are intended to cover non-exclusive inclusions. For example, a process, method, system, product, or device that includes a series of steps or units is not necessarily limited to those clearly listed. Those steps or units can include other steps or units that are not clearly listed or are inherent to such process, method, product, or device.

### Embodiment 1

This embodiment provides a method for allocating equipment usage right, which can be applied to a server side, and can run in a mobile personal computer, a workstation, a POS machine, a server or a similar electronic apparatus with computing capability. Running on different electronic apparatuses only have a difference in the execution entities of the solution, and those skilled in the art can foresee that running on different electronic apparatuses can produce the same technical effect.

In the method for allocating equipment usage right provided in this embodiment, by acquiring and recording biometric information of a user currently using the electronic equipment, the usage state of each electronic equipment can be recorded, and the current real-time usage state of each electronic equipment can be obtained, so as to use the current real-time usage state and historical records to formulate a strategy for allocating equipment usage right to electronic equipment, and then send the allocating results to the users designated by the strategy. It can solve the problem in the related art that the real information of users using electronic equipment cannot be accurately obtained, and the target customers cannot be attracted. It can accurately detect the identity of the user using electronic equipment, thereby determining the target customers based on more accurate user information, and attracting users to use electronic equipment through the equipment usage right allocated to the target customers, thus increasing the usage rate of each electronic equipment.

As shown in FIG. 1, the method for allocating equipment usage right provided in this embodiment includes the following steps.

In step 101, for each of one or more electronic equipment, biometric information of a user currently using the electronic equipment which is acquired by the electronic equipment in real time is obtained, to obtain a current usage state of the electronic equipment, and based on the current usage state of the electronic equipment, a historical usage record of the electronic equipment is updated.

The biometric information is obtained by a target sensor configured on the electronic equipment and indicates designated human biological characteristic. The human biological characteristic can include at least one of: a facial feature, a fingerprint feature, and an iris feature. For example, for entertainment electronic equipment, a camera can be provided to obtain facial information of the user, so as to obtain the facial features and iris features of the user who is currently using the electronic equipment. For another example, for video game electronic equipment that requires manual operation, a touchable manual operation panel can be configured to obtain fingerprint features of the user who is operating the electronic equipment.

It should be noted that the electronic equipment acquiring the biometric information is performed in real time at a relatively short period, for example, acquiring once every 5 seconds, so that the real identity of the user who is using the electronic equipment can be obtained, and the situation which is caused by using an equipment boot mode similar to swiping card and where the user who is using the equipment is not the user who activated the equipment can be avoided. By acquiring biometric information in real time and according determining the user's identity, the record can be more accurate, real and effective.

The current usage state of an electronic equipment is used to indicate whether the electronic equipment is currently being used. When the electronic equipment is being used, the current usage state also includes the acquired biometric information of the user currently using the electronic equipment. After obtaining the current usage state of any electronic equipment, the historical usage record of the corresponding electronic equipment is updated based on the current usage state.

For example, a camera is installed on entertainment electronic equipment to capture facial information of a user who is using the electronic equipment. The camera acquires a picture every 5 seconds. If no human face is recognized in the picture, it is determined that the electronic equipment is not currently in use. The acquisition time and the unused state at that time are recorded in the historical usage record. If a face is detected in the picture, then the facial features of the face are extracted, and the facial features and acquisition time are stored in the historical usage record of the electronic equipment.

Optionally, in order to monitor the usage state of electronic equipment in real time, users who are using electronic equipment can be authenticated in real time. The specific method includes: after obtaining biometric information of a user who is currently using the electronic equipment acquired by the electronic equipment in real time, identifying the user who is currently using the electronic equipment based on the biometric information as a current user, and determining whether the current user has a usage permission; if the determination result is no, the electronic equipment is closed. The closing method can be through software shutdown or power off. This embodiment does not specifically limit the way of closing the electronic equipment.

In step 102, based on the current usage state and/or the historical usage record of each electronic equipment, targeted using objects to be allocated with equipment usage right of corresponding electronic equipment are determined.

Equipment usage right refers to a permission or right to use an equipment, which can be used as a means to attract users to use. Optionally, the equipment usage right can refer to a usage permission of whether permitted to use the equipment or not, and can also be a coupon for using the equipment. If every start of the equipment needs to consume currency resources, the equipment usage right can reduce the amount of currency resources to be consumed for using the electronic equipment. For example, for video game electronic equipment, every start needs to consume 5 game coins (game coins can be exchanged from legal currency. It can also be obtained by other means), then the equipment usage right can be that the player only needs 3 game coins for every start, offering the player a coupon of 2 game coins.

For the equipment usage right, a user who has the usage right needs to be designated. Optionally, in addition to designating users who has the usage right, the time period for using the usage right can also be designated. In this embodiment, based on the current usage state and/or the historical usage record of each electronic equipment, targeted using objects to be allocated with equipment usage right of corresponding electronic equipment are determined.

Optionally, the following several optional specific implementation examples of step 102 can be performed.

The first optional implementation is determining targeted using objects to be allocated with equipment usage right of corresponding electronic equipment based on the historical usage record of each electronic equipment, which specifically includes the following steps.

In step 11, an idle time period for the corresponding electronic equipment is determined based on the historical usage record of each electronic equipment, and one or more users who use an electronic equipment of the same type as the corresponding electronic equipment at a frequency higher than a preset threshold are determined as the targeted using objects. In order to improve the usage rate of each electronic equipment, an idle time period can be determined based on the historical usage record, and the equipment usage right of the idle time period is allocated to attract users to use the electronic equipment.

The way to determine the idle time period can be dividing multiple time periods at preset time intervals and counting the usage frequency of the equipment in each time period, so as to determine the time period when the usage frequency of the equipment is low (below a preset threshold, or ranked after a designated percentile by frequencies from high to low) as the idle time period. For example, based on the statistics of historical usage, for video game electronic equipment, the usage frequency is lower in the mornings of the working days than in other time periods, and the mornings of the working days can be determined as the idle time period for the electronic equipment.

In addition to determining the idle time period, targeted using objects are to be determined. In order to improve the usage rate of equipment usage right, the targeted using objects who use an electronic equipment of the same type as the corresponding electronic equipment at a frequency higher than a preset threshold may be determined, so as to increase the probability of using the equipment usage right.

For example, when allocating equipment usage right of shooting video game equipment A during an idle time period, based on the statistics of historical usage, for player (user) C, the frequency of historical usage of shooting video game equipment B is higher, so the equipment usage right of video game equipment A during the idle time period is allocated to player C.

In step 12, equipment usage right of the idle time period is allocated to the targeted using objects.

After determining the idle time period and the targeted using objects, the equipment usage right of the idle time period is allocated to the targeted using objects, that is, the targeted using objects are pre-authorized. The allocating result is saved in the server, so that when a targeted using object uses the corresponding electronic equipment, the corresponding equipment usage right are matched and the usage right (authorization) can be executed.

The second optional implementation is determining the targeted using objects to be allocated with equipment usage right of corresponding electronic equipment based on the current usage state of each electronic equipment, which specifically includes the following steps.

In step 21, a currently unused electronic equipment is determined based on the current usage state of each electronic equipment.

In step 22, based on current usage states of other electronic equipment in an area where the currently unused electronic equipment is located, one or more current users in the area are determined to obtain the targeted using objects. For example, current usage states of a plurality of electronic equipment in the current time period (a period of time till to the current moment) in the same amusement park (area) are obtained, and then current users in the area are determined.

In step 23, equipment usage right of using currently unused electronic equipment within a preset time period is allocated to the targeted using objects, where the preset time period may be a certain period of time from the current moment. After the current users in the area are determined, these users may be allocated equipment usage right for using idle electronic equipment a designated period of time (time period) from the current moment, so as to attract the current users in the area to use the idle electronic equipment.

The third optional implementation is targeted using objects to be allocated with equipment usage right of corresponding electronic equipment based on the current usage state and the historical usage record of each electronic equipment, which specifically includes the following steps.

In step 31, based on the historical usage record of each electronic equipment, an idle time period for the corresponding electronic equipment is determined.

In step 32, when the idle time period is reached, it is determined whether the corresponding electronic equipment is being used.

In step 33, if not, based on current usage states of other electronic equipment in an area where the currently unused electronic equipment is located, one or more current users in the area are determined to obtain the targeted using objects.

In step 34, equipment usage right of using the corresponding electronic equipment within the idle time period are allocated to the targeted using objects.

For example, by pre-determining the idle time period for each electronic equipment as the working hours from Monday to Friday according to historical usage records, for an electronic equipment, when it is in the idle time period, if it is determined that the electronic equipment is not currently in use according to the current usage state, based on the current usage states of other electronic equipment in the same area, the users who are currently in the area are determined, and a short-term equipment usage right can be allocated to these users to attract the users to use electronic equipment that are idle and increase the usage rate of the idle equipment.

In step 103, the information of the allocating result is sent to the targeted using objects.

The sending method can be any sending method or a combination of multiple specific sending methods. For example, the information of the allocating result can be pushed through a client to a mobile terminal of a targeted using object. Alternatively, the information of the allocating result can also be sent to a mobile terminal of a targeted using object in the form of a short message.

The method for allocating equipment usage right provided in the embodiment of this application is applicable to a server side that controls a plurality of electronic equipment. By receiving the biometric information acquired by each electronic equipment in real time, the usage state of each electronic equipment can be monitored, the identity of user using the electronic equipment can be determined, and then the equipment usage right (a usage permission and/or a discount right) of an idle electronic equipment can be issued to targeted users according to a certain rule, so to attract usage from other users, and thus balancing the usage frequency of each electronic equipment.

It should be noted that the steps shown in the flowchart of the accompanying drawings can be executed in a computer system such as a set of computer-executable instructions, and although the logical sequence is shown in the flowchart, in some cases, the steps shown or described can be performed in a different order than here.

Through the description of the above embodiments, those skilled in the art can clearly understand that the method according to the above embodiment can be implemented by means of software based on a necessary general hardware platform. However, it can also be implemented by hardware, but in many cases the former is better implementation. Based on this understanding, the technical solution of this application essentially or with the part that contributes to the existing technology can be embodied in the form of a software product, and the computer software product is stored in a storage medium (such as ROM/RAM, magnetic disk, optical disc), including several instructions to enable a terminal device (which can be a mobile phone, a computer, a server, or a network device, etc.) to execute the method described in each embodiment of the present application.

### Embodiment 2

In this embodiment, a device for allocating equipment usage right is also provided, which is used to implement the above-mentioned embodiment 1 and its preferred implementations. Terms or implementations that are not described in detail in this embodiment can be referred to the related descriptions in Embodiment 1, and those that have already been described will not be repeated.

The term “module” as used below is a combination of software and/or hardware that can implement predetermined functions. Although the devices described in the following embodiments are preferably implemented by software, the implementation of hardware or a combination of software and hardware can also be conceived.

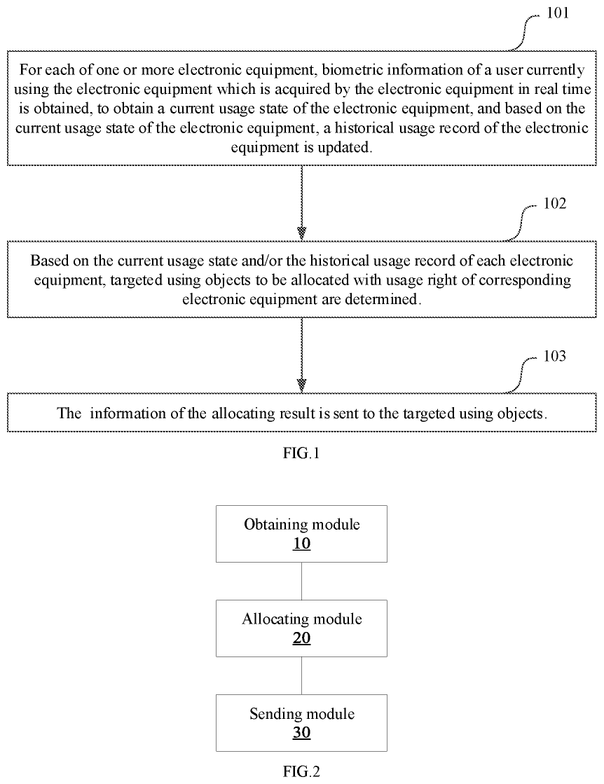

FIG. 2 is a schematic diagram of a device for allocating equipment usage right according to an embodiment of the present application. As shown in FIG. 2, the device includes an obtaining module 10, an allocating module 20, and a sending module 30.

The obtaining module is configured to, for each of one or more electronic equipment, obtain biometric information of a user currently using the electronic equipment which is acquired by the electronic equipment in real time, to obtain a current usage state of each electronic equipment, and based on the current usage state of each electronic equipment, update a historical usage record of the electronic equipment, where the biometric information is obtained by a target sensor configured on the electronic equipment and indicates designated human biological characteristic. The allocating module is configured to, based on the current usage state and/or the historical usage record of the electronic equipment, determine targeted using objects to be allocated with equipment usage right of corresponding electronic equipment. The sending module is configured to send information of the allocating result to the targeted using objects.

Optionally, the equipment usage right comprises a usage permission of corresponding electronic equipment and/or a discount right to consumed resources for using corresponding electronic equipment.

Optionally, the allocating module includes: a first determining unit, configured to determine an idle time period for the corresponding electronic equipment based on the historical usage record of each electronic equipment, and determine one or more users who use an electronic equipment of the same type as the corresponding electronic equipment at a frequency higher than a preset threshold as the targeted using objects; and a first allocating unit configured to allocate equipment usage right of using the corresponding electronic equipment within the idle time period to the targeted using objects.

Optionally, the allocating module includes: determining a currently unused electronic equipment based on the current usage state of each electronic equipment; a second determining unit configured to, based on current usage states of other electronic equipment in an area where the currently unused electronic equipment is located, determine one or more current users in the area to obtain the targeted using objects; and a second allocating unit configured to allocate the equipment usage right of using the currently unused electronic equipment within a preset time period to the targeted using objects.

Optionally, the allocating module includes: a third determining unit, configured to, based on the historical usage record of each electronic equipment, determine an idle time period for the corresponding electronic equipment; a judging unit configured to, when the idle time period is reached, judge whether the corresponding electronic equipment is being used; a fourth determining unit configured to, if not, based on current usage states of other electronic equipment in an area where the currently unused electronic equipment is located, determine one or more current users in the area to obtain the targeted using objects; and a third allocating unit configured to allocate the equipment usage right of using the corresponding electronic equipment within the idle time period to the targeted using objects.

Optionally, the sending module includes: a pushing unit configured to push the information of the allocating result to clients of mobile terminals of the targeted using objects; and/or, a sending unit configured to send the information of the allocating result to mobile terminals of the targeted using objects in the form of short messages.

Optionally, the human biological characteristic includes at least one of: a facial feature, a fingerprint feature, and an iris feature.

Optionally, the device may further include an identifying module configured to, after obtaining the biometric information of the user currently using the electronic equipment which is acquired by the electronic equipment in real time, identify the user currently using the electronic equipment according to the biometric information; a determining module configured to determine whether the current user has a usage permission; and a closing module configured to close the electronic equipment if the determination result is no.

It should be noted that each of the above modules can be implemented by software or hardware. For the latter, it can be implemented in the following way, but not limited to this: the above modules are all located in the same processor; or, the above modules can be distributed in different processors in any form of combination.

Apparently, those skilled in the art should understand that the above-mentioned modules or steps of this application can be implemented by a general computing device, and they can be concentrated on a single computing device or distributed in a network composed of multiple computing devices. Alternatively, they can be implemented with program codes executable by the computing device, so that they can be stored in the storage device for execution by the computing device, and in some cases, the steps shown or described here can be executed in a different order than here, or fabricate them into individual integrated circuit modules, or fabricate multiple modules or steps of them into a single integrated circuit module. In this way, this application is not limited to any specific combination of hardware and software.

### Embodiment 3

The embodiment of the present application also provides a non-volatile readable storage medium, the storage medium stores computer readable instructions, wherein the computer readable instructions are configured to execute steps in any of the above method embodiments when running. Optionally, in this embodiment, the above-mentioned storage medium can include but is not limited to: U disk, read-only memory (ROM for short), random access memory (RAM for short), and various media that can store computer-readable instructions, such as mobile hard disks, magnetic disks, or optical disks.

### Embodiment 4

The embodiment of the present application also provides an electronic apparatus, including a memory and a processor, the memory stores computer readable instructions, and the processor is configured to run the computer readable instructions to execute steps of any of the above method embodiments.

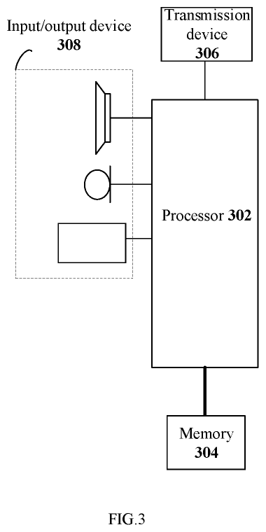

Optionally, the aforementioned electronic apparatus can further include a transmission device and an input-output device, wherein the transmission device is connected to the aforementioned processor, and the input-output device is connected to the aforementioned processor. FIG. 3 is a block diagram of the hardware structure of an electronic apparatus according to an embodiment of the present application. As shown in FIG. 3, the electronic apparatus can include one or more (only one is shown in FIG. 3) processors 302 (the processor 302 can include, but is not limited to, a processing device such as a microprocessor MCU or a programmable logic device FPGA) and a memory 304 for storing data. Optionally, the above electronic apparatus can also include a transmission device 306 and an input/output device 308 for communication functions. Those of ordinary skill in the art can understand that the structure shown in FIG. 3 is only for illustration, and does not limit the structure of the above electronic apparatus. For example, the electronic apparatus can also include more or fewer components than shown in FIG. 3, or have a different configuration from that shown in FIG. 3.

The memory 304 can be configured to store computer-readable instructions, for example, software programs and modules of application software, such as the computer-readable instructions corresponding to the image recognition method in the embodiment of the present application. The processor 302 runs the computer-readable instructions stored in the memory 304 to execute various functional applications and data processing, that is, to implement the above-mentioned methods. The memory 304 can include a high-speed random access memory, and can also include a non-volatile memory, such as one or more magnetic storage devices, flash memory, or other non-volatile solid-state memory. In some examples, the memory 304 can further include a memory remotely provided with respect to the processor 302, and these remote memories can be connected to the electronic apparatus through a network. Examples of the aforementioned networks include, but are not limited to, the Internet, corporate intranets, local area networks, mobile communication networks, and combinations thereof.

The transmission device 306 is configured to receive or send data via a network. The above-mentioned specific examples of the network can include a wireless network provided by a communication operator of an electronic device. In an example, the transmission device 306 includes a Network Interface Controller (NIC for short), which can be connected to other network devices through a base station so as to communicate with the Internet. In an example, the transmission device 306 can be a radio frequency (RF for short) module, which is configured to communicate with the Internet in a wireless manner.

The foregoing descriptions are only preferred embodiments of the application, and are not intended to limit the application. For those skilled in the art, the application can have various modifications and changes. Any modification, equivalent replacement, improvement, etc. made within the principles of this application shall be included in the protection scope of this application.

What is claimed is:

1. A method for allocating equipment usage right, the method comprising:
for each of one or more electronic equipment,
obtaining biometric information of a user currently using the electronic equipment which is acquired by the electronic equipment in real time, to obtain a current usage state of the electronic equipment,
based on the current usage state of the electronic equipment, updating a historical usage record of the electronic equipment, wherein the biometric information is obtained by a target sensor configured on the electronic equipment and indicates designated human biological characteristic;
based on the current usage state and/or the historical usage record of each of the electronic equipment, determining one or more targeted using objects to be allocated with equipment usage right of corresponding electronic equipment; and
sending information of the allocating result to the targeted using objects.

2. The method of claim 1, wherein the equipment usage right comprises
a usage permission of corresponding electronic equipment; and/or
a discount right to consumed resources for using corresponding electronic equipment.

3. The method of claim 1, wherein based on the historical usage record of each of the electronic equipment, determining one or more targeted using objects to be allocated with equipment usage right of corresponding electronic equipment, comprises:
based on the historical usage record of each of the electronic equipment, determining an idle time period for corresponding electronic equipment,
determining one or more users who use an electronic equipment of a same type as the corresponding electronic equipment at a frequency higher than a preset threshold as the targeted using objects; and
allocating equipment usage right of using the corresponding electronic equipment within the idle time period to the targeted using objects.

4. The method of claim 1, wherein based on the current usage state of each of the electronic equipment, determining one or more targeted using objects to be allocated with equipment usage right of corresponding electronic equipment, comprises:
determining a currently unused electronic equipment based on the current usage state of each of the electronic equipment;
based on current usage states of other electronic equipment in an area where the currently unused electronic equipment is located, determining one or more current users in the area, to obtain the targeted using objects; and
allocating equipment usage right of using the currently unused electronic equipment within a preset time period to the targeted using objects.

5. The method of claim 1, wherein based on the current usage state and the historical usage record of each of the electronic equipment, determining one or more targeted using objects to be allocated with equipment usage right of corresponding electronic equipment, comprises:
based on the historical usage record of each of the electronic equipment, determining an idle time period for corresponding electronic equipment;
when the idle time period is reached, determining whether the corresponding electronic equipment is being used;
if not, based on current usage states of other electronic equipment in an area where the currently unused electronic equipment is located, determining one or more current users in the area, to obtain the targeted using objects; and
allocating equipment usage right of using the corresponding electronic equipment within the idle time period to the targeted using objects.

6. The method of claim 1, wherein sending information of the allocating result to the targeted using objects comprises:
pushing the information of the allocating result to a client of a mobile terminal of the targeted using object; and/or,
sending the information of the allocating result to a mobile terminal of the targeted using object in a form of short message.

7. The method of claim 1, wherein the human biological characteristic comprises at least one of: a facial feature, a fingerprint feature, and an iris feature.

8. The method of claim 1, wherein after obtaining the biometric information of the user currently using the electronic equipment which is acquired by the electronic equipment in real time, the method further comprises:
identifying the user currently using the electronic equipment according to the biometric information as a current user;
determining whether the current user has a usage permission; and
closing the electronic equipment if the determination result is no.

9. A non-volatile readable storage medium having at least one computer readable instructions stored in the non-volatile readable storage medium, wherein the computer readable instructions are configured to, when running, perform a method for allocating equipment usage right as described in claim 1.

10. An electronic apparatus comprising a memory and a processor, the memory storing computer-readable instructions, the processor being configured to run the computer-readable instructions to perform a method for allocating equipment usage right, comprising:
for each of one or more electronic equipment,
obtaining biometric information of a user currently using the electronic equipment which is acquired by the electronic equipment in real time, to obtain a current usage state of the electronic equipment,
based on the current usage state of the electronic equipment, updating a historical usage record of the electronic equipment, wherein the biometric information is obtained by a target sensor configured on the electronic equipment and indicates designated human biological characteristic;
based on the current usage state and/or the historical usage record of the electronic equipment, determining one or more targeted using objects to be allocated with equipment usage right of corresponding electronic equipment; and
sending information of the allocating result to the targeted using objects.
